(19) United States
(12) Patent Application Publication
(10) Pub. No.: US 2019/0123381 A1
(43) Pub. Date: Apr. 25, 2019

(54) NONAQUEOUS ELECTROLYTE SECONDARY BATTERY POROUS LAYER

(71) Applicant: Sumitomo Chemical Company, Limited, Tokyo (JP)

(72) Inventor: Toshihiko OGATA, Osaka (JP)

(21) Appl. No.: 16/169,101

(22) Filed: Oct. 24, 2018

(30) Foreign Application Priority Data
Oct. 24, 2017 (JP) 2017-205594

(51) Int. Cl. H01M 10/058; H01M 2/16; H01M 10/0525; H01M 4/62

(52) U.S. Cl. CPC H01M 10/058; H01M 2/16; H01M 2004/021; H01M 4/621; H01M 4/624; H01M 10/0525

(57) ABSTRACT

The present invention provides a nonaqueous electrolyte secondary battery having excellent heat resistance and excellent ion permeability. A nonaqueous electrolyte secondary battery porous layer in accordance with an aspect of the present invention includes an aramid filler having a particle diameter of 0.01 μm to 10 μm.

This Nonprovisional application claims priority under 35 U.S.C. § 119 on Patent Application No. 2017-205594 filed in Japan on Oct. 24, 2017, the entire contents of which are hereby incorporated by reference.

### TECHNICAL FIELD

The present invention relates to (i) a nonaqueous electrolyte secondary battery porous layer, (ii) a laminated separator for a nonaqueous electrolyte secondary battery (hereinafter referred to as “nonaqueous electrolyte secondary battery laminated separator”), (iii) a member for a nonaqueous electrolyte secondary battery (hereinafter referred to as “nonaqueous electrolyte secondary battery member”), and (iv) a nonaqueous electrolyte secondary battery.

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries have recently been developed as on-vehicle batteries.

As a member of such a nonaqueous electrolyte secondary battery, a separator having excellent heat resistance has been developed.

For example, Patent Literature 1 discloses a nonaqueous electrolyte secondary battery laminated separator including (i) a porous film and (ii) a porous layer made of an aramid resin which is a heat-resistant resin.

### CITATION LIST

### Patent Literature

[Patent Literature 1]

Japanese Patent Application Publication, Tokukai, No. 2001-23602 (Publication Date: Jan. 26, 2001)

### SUMMARY OF INVENTION

### Technical Problem

However, the above-described conventional nonaqueous electrolyte secondary battery, which includes a porous layer made of an aramid resin, has room for improvement in terms of air permeability.

Therefore, it is an object of an aspect of the present invention to achieve a nonaqueous electrolyte secondary battery having excellent air permeability.

### Solution to Problem

As a result of diligent study, the inventors of the present invention found that a nonaqueous electrolyte secondary battery porous layer, which includes an aramid filler having (i) a certain particle diameter or (ii) a certain particle diameter and a certain aspect ratio, has heat resistance and further excellent air permeability. The inventors of the present invention thus completed the present invention. Therefore, an aspect of the present invention encompasses the following [1] through [5].

[1] A nonaqueous electrolyte secondary battery porous layer including an aramid filler, the aramid filler having a particle diameter of 0.01 μm to 10 μm.
[2] The nonaqueous electrolyte secondary battery porous layer described in [1], in which an aspect ratio of a projection image of the aramid filler is in a range of 1 to 100.
[3] A nonaqueous electrolyte secondary battery laminated separator including: a polyolefin porous film; and a nonaqueous electrolyte secondary battery porous layer described in [1] or [2], the nonaqueous electrolyte secondary battery porous layer being disposed on at least one surface of the polyolefin porous film.
[4] A nonaqueous electrolyte secondary battery member including: a positive electrode, a nonaqueous electrolyte secondary battery porous layer described in [1] or [2] or a nonaqueous electrolyte secondary battery laminated separator described in [3], and a negative electrode, the positive electrode, the nonaqueous electrolyte secondary battery porous layer or the nonaqueous electrolyte secondary battery laminated separator, and the negative electrode being arranged in this order.
[5] A nonaqueous electrolyte secondary battery including a nonaqueous electrolyte secondary battery porous layer described in [1] or [2] or a nonaqueous electrolyte secondary battery laminated separator described in [3].

### Advantageous Effects of Invention

A nonaqueous electrolyte secondary battery porous layer in accordance with an aspect of the present invention advantageously has excellent air permeability.

### DESCRIPTION OF EMBODIMENTS

The following description will discuss an embodiment of the present invention in detail. Note that numerical expressions such as “A to B” herein mean “not less than A and not more than B”.

[1. Nonaqueous Electrolyte Secondary Battery Porous Layer]

A nonaqueous electrolyte secondary battery porous layer in accordance with an embodiment of the present invention (hereinafter also simply referred to as “porous layer” or “porous layer in accordance with an embodiment of the present invention”) is a nonaqueous electrolyte secondary battery porous layer including an aramid filler having a particle diameter of 0.01 μm to 10 μm. According to the nonaqueous electrolyte secondary battery porous layer in accordance with an embodiment of the present invention, an aspect ratio of a projection image of the aramid filler is 1 to 100.

A “porous layer” herein has a structure in which many pores, connected to one another, are provided, so that the porous layer is a layer through which a gas or a liquid can pass from one surface to the other. Further, in a case where the porous layer in accordance with an embodiment of the present invention is used as a member included in a nonaqueous electrolyte secondary battery laminated separator, the porous layer can be a layer which, serving as an outermost layer of the separator (laminated body), comes into contact with an electrode.

<Aramid Filler>

An “aramid filler” herein means a filler containing an aramid resin as a main component. The expression “a filler contains an aramid resin as a main component” herein means that the aramid is contained in a percentage ratio of ordinarily not less than 50% by volume, preferably not less than 90% by volume, and more preferably not less than 95% by volume, relative to 100% by volume of the filler.

The porous layer in accordance with an embodiment of the present invention contains an aramid filler in an amount of ordinarily not less than 50% by weight, preferably not less than 70% by weight, and more preferably not less than 90% by weight, relative to 100% by weight of a total weight of the porous layer.

The aramid filler in accordance with an embodiment of the present invention contains an aramid resin such as an aromatic polyamide or a wholly aromatic polyamide. Examples of the aramid resin encompass para-aramid and meta-aramid. Among these, para-aramid is preferable.

Examples of a method of preparing the para-aramid encompass, but are not particularly limited to, condensation polymerization of para-oriented aromatic diamine and para-oriented aromatic dicarboxylic acid halide. In such a case, para-aramid to be obtained substantially includes repeating units in which amide bonds are bonded at para positions or corresponding oriented positions (for example, oriented positions that extend coaxially or parallel in opposite directions such as the cases of 4,4′-biphenylene, 1,5-naphthalene, and 2,6-naphthalene) of aromatic rings. Examples of the para-aramid encompass para-aramids each having a para-oriented structure or a structure corresponding to a para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and paraphenylene terephthalamide/2,6-dichloroparaphenylene terephthalamide copolymer. Among these, poly(paraphenylene terephthalamide) is preferable.

A solution of the poly(paraphenylene terephthalamide) (hereinafter referred to as “PPTA”) can be prepared by a specific method. Examples of such a specific method encompass a method including the following steps (1) through (4).

(1) N-methyl-2-pyrrolidone (hereinafter also referred to as “NMP”) is introduced into a flask which is dried. Then, calcium chloride, which has been dried at 200° C. for 2 hours, is added. Then, the flask was heated to 100° C. to completely dissolve the calcium chloride.
(2) A temperature of the solution obtained in the step (1) is returned to room temperature, and then paraphenylenediamine (hereinafter abbreviated as “PPD”) is added. Then, the PPD is completely dissolved.
(3) While a temperature of the solution obtained in the step (2) is maintained at 20±2° C., terephthalic acid dichloride (hereinafter referred to as “TPC”) was added in ten separate portions at approximately 5-minute intervals.
(4) While a temperature of the solution obtained in the step (3) is maintained at 20±2° C., the solution was matured for 1 hour, and was then stirred under reduced pressure for 30 minutes to eliminate air bubbles, so that the solution of the PPTA is obtained.

A solution containing the filler of PPTA as a para-aramid can be prepared by a specific method. Examples of the specific method encompass a method in which the solution of the PPTA obtained in the steps (1) through (4) above is stirred at 300 rpm and at 40° C. for 1 hour so that the filler of the PPTA are deposited.

Examples of a method of preparing the meta-aramid encompass, but are not particularly limited to, (1) condensation polymerization of (a) meta-oriented aromatic diamine and (b) meta-oriented aromatic dicarboxylic acid halide or para-oriented aromatic dicarboxylic acid halide and (2) condensation polymerization of (a) meta-oriented aromatic diamine or para-oriented aromatic diamine and (b) meta-oriented aromatic dicarboxylic acid halide. In such a case, the meta-aramid to be obtained includes a repeating unit in which amide bonds are bonded at meta positions or corresponding oriented positions of aromatic rings. Examples of the meta-aramid encompass poly(methaphenylene isophthalamide), poly(metabenzamide), poly(methaphenylene-4,4′-biphenylene dicarboxylic acid amide), poly(methaphenylene-2,6-naphthalene dicarboxylic acid amide), and a methaphenylene terephthalamide/2,6-dichloroparaphenylene terephthalamide copolymer.

The porous layer in accordance with an embodiment of the present invention can include a filler other than the aramid filler. The filler other than the aramid filler can be selected from an organic powder, an inorganic powder, and a mixture of an organic powder and an inorganic powder.

Examples of the organic powder encompass powders made of organic matter such as: (i) a homopolymer of a monomer such as styrene, vinyl ketone, acrylonitrile, methyl methacrylate, ethyl methacrylate, glycidyl methacrylate, glycidyl acrylate, or methyl acrylate or (ii) a copolymer of two or more of such monomers; fluorine-based resins such as polytetrafluoroethylene, ethylene tetrafluoride-propylene hexafluoride copolymer, ethylene tetrafluoride-ethylene copolymer, and polyvinylidene fluoride; melamine resin; urea resin; polyolefin; and polymethacrylate. The filler can be made of one of these organic powders, or can be made of two or more of these organic powders in combination. Among these organic powders, a polytetrafluoroethylene powder is preferable in view of chemical stability.

Examples of the inorganic powder encompass powders made of inorganic matters such as metal oxide, metal nitride, metal carbide, metal hydroxide, carbonate, and sulfate. Specific examples of the inorganic powder encompass powders made of inorganic matters such as alumina, boehmite, silica, titanium dioxide, aluminum hydroxide, and calcium carbonate. The filler can be made of one of these inorganic powders, or can be made of two or more of these inorganic powders in combination. Among these inorganic powders, an alumina powder is preferable in view of chemical stability.

<Particle Diameter of Aramid Filler>

The aramid filler contained in the porous layer in accordance with an embodiment of the present invention has a particle diameter of preferably 0.01 μm to 10 μm and more preferably 0.05 μm to 10 μm. Note that particle diameter is a value obtained by (i) capturing, with use of a scanning electron microscope (SEM), an electron micrograph (SEM image) of a surface of an aramid filler from above (vertically above) the aramid filler, (ii) producing a projection image of the aramid filler from the electron micrograph, and (iii) calculating a long axis of the projection image of the aramid filler.

The particle diameter can be measured by a specific method such as a method including the following steps (1) through (3).

(1) A step in which (i) the aramid filler, which has been dried on a glass plate and is in a solution, is subjected to an SEM surface observation (observation of a reflection electron image) from directly above at an acceleration voltage of 0.5 kV with use of a field emission scanning electrode microscope JSM-7600F manufactured by JEOL Ltd. and (ii) an SEM image is captured so that an average particle diameter is 50 pixels.
(2) A step in which (i) the SEM image obtained in the step (1) is imported into a computer, (ii) the image is, with use of free software IMAGEJ for image analysis (distributed by National Institutes of Health (NIH), divided at a luminance at which the aramid filler particles are detectable, and (iii) luminance holes are filled so that all areas inside the aramid filler are detectable as aramid filler areas.
(3) A step in which a long axis of each of the detected aramid filler particles is calculated. Note that an average value of the long axes of the aramid filler particles thus calculated is used as a particle diameter of the aramid filler.

In a case where the particle diameter is less than 0.01 μm, the aramid filler may fill the pores of the porous layer which includes the aramid filler. This may cause ion permeability of a battery to be insufficient. Meanwhile, in a case where the particle diameter is more than 10 μm, the aramid filler may be unevenly present, so that heat resistance of the porous layer may be lost.

In an embodiment of the present invention, the aramid filler can have any shape, examples of which encompass a substantially spherical shape, a plate-like shape, a pillar shape, a needle shape, a whisker-like shape, and a fibrous shape. Among these, a substantially spherical shape is preferable because substantially spherical shape allows uniform pores to be easily made.

<Aspect Ratio of Aramid Filler>

The aramid filler contained in the porous layer in accordance with an embodiment of the present invention is configured so that an aspect ratio of a projection image of the aramid filler is preferably 1 to 100 and more preferably 1 to 50. Note that an aspect ratio is a value obtained by (i) capturing, with use of a scanning electron microscope (SEM), an electron micrograph (SEM image) of a surface of an aramid filler from above (vertically above) the aramid filler, (ii) producing a projection image of the aramid filler from the electron micrograph, and (iii) calculating a ratio of a length of a short axis (short-axis diameter) to a length of a long axis (long-axis diameter) of the projection image of the aramid filler. That is, the aspect ratio is a value indicative of a shape of the aramid filler when the aramid filler is observed directly from above.

The aspect ratio can be measured by a specific method such as a method including the following steps (1) through (4).

(1) A step in which the aramid filler, which has been dried on a glass plate and is in a solution, is subjected to an SEM surface observation (observation of a reflection electron image) from directly above at an acceleration voltage of 0.5 kV with use of a field emission scanning electrode microscope JSM-7600F manufactured by JEOL Ltd., so that an SEM image is captured.
(2) A step in which (i) the SEM image obtained in the step (1) is imported into a computer, (ii) the image is, with use of free software IMAGEJ for image analysis (distributed by National Institutes of Health (NIH), divided at a luminance at which the aramid filler particles are detectable, and (iii) luminance holes are filled so that all areas inside the aramid filler are detectable as aramid filler areas.
(3) A step in which an aspect ratio of each of the detected aramid filler particles is calculated. Note that the aspect ratio is a value obtained by (i) approximating the shape of each particle of the aramid filler to an elliptical shape, (ii) calculating a long-axis diameter and a short-axis diameter of the elliptical shape, and (iii) dividing the long-axis diameter by the short-axis diameter.
(4) A step in which an average value of aspect ratios (obtained in the step (3)) of the projection image of the aramid filler is calculated and is used as an aspect ratio of the projection image of the aramid filler.

The aspect ratio of the projection image of the aramid filler serves as an index which indicates uniformity of distribution of the aramid filler in the porous layer. In a case where the aspect ratio is close to 1, the shape and the distribution of constituents of the porous layer are uniform, so that the aramid filler can densely-packed easily. Meanwhile, in a case where the aspect ratio is large, constituents in a structure of the porous layer are not uniformly arranged. This indicates that the shape of the porous layer is less uniform.

In a case where the aspect ratio is more than 100, a void between the particles of the aramid filler in the porous layer tends to be small. This may increase air permeability.

<Other Components>

The porous layer in accordance with an embodiment of the present invention can include a resin (hereinafter also referred to as “binder resin”) other than the aramid filler. The resin can serve as a binder resin to (i) bind particles of the aramid filler to each other, (ii) bind the aramid filler to an electrode, and (iii) bind the aramid filler to a porous film (porous base material).

The resin is preferably (i) insoluble in a nonaqueous electrolyte of a nonaqueous electrolyte secondary battery and (ii) electrochemically stable when the nonaqueous electrolyte secondary battery is in normal use. Specific examples of the resin encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; a fluorine-containing rubber having a glass transition temperature of equal to or less than 23° C., among the fluorine-containing resins; a polyamide-based resin such as an aramid resin (aromatic polyamide and wholly aromatic polyamide); polyester-based resins such as aromatic polyester (e.g., polyarylate) and liquid crystal polyester; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, and polyether amide; and water-soluble polymers such as polyvinyl alcohol, polyethylene glycol, cellulose ether, sodium alginate, polyacrylic acid, polyacrylamide, and polymethacrylic acid.

Alternatively, a water-insoluble polymer can be suitably used as the resin contained in the porous layer in accordance with an embodiment of the present invention. In other words, the porous layer in accordance with an embodiment of the present invention, which contains the water-insoluble polymer (e.g., acrylate resin) as the resin and the aramid filler, is produced preferably with use of an emulsion obtained by dispersing the water-insoluble polymer in an aqueous solvent.

Note that the water-insoluble polymer means a polymer that does not dissolve in an aqueous solvent but becomes particles so as to be dispersed in an aqueous solvent. “Water-insoluble polymer” means a polymer which has an insoluble content of not less than 90% by weight in a case where 0.5 g of the polymer is mixed with 100 g of water at 25° C. Meanwhile, the “water-soluble polymer” refers to a polymer which has an insoluble content of less than 0.5% by weight in a case where 0.5 g of the polymer is mixed with 100 g of water at 25° C. The shape of the particles of the water-insoluble polymer is not limited to any particular one, but is preferably a spherical shape.

The water-insoluble polymer is produced as polymer particles by, for example, polymerizing, in an aqueous solvent, a monomer composition containing a monomer (described later).

The aqueous solvent contains water, and is not limited to any particular one, provided that the water-insoluble polymer particles can be dispersed in the aqueous solvent.

The aqueous solvent can contain an organic solvent which can be dissolved in water at any ratio to the water. Examples of such an organic solvent encompass methanol, ethanol, isopropyl alcohol, acetone, tetrahydrofuran, acetonitrile, and N-methylpyrrolidone. The aqueous solvent can also contain (i) a surfactant such as sodium dodecylbenzene sulfonate, (ii) a dispersing agent such as a polyacrylic acid or a sodium salt of carboxymethyl cellulose, and/or (iii) the like.

Note that the porous layer in accordance with an embodiment of the present invention can contain a single kind of resin or can contain a mixture of two or more kinds of resins.

Specific examples of the aromatic polyamides encompass poly(paraphenylene terephthalamide), poly(methaphenylene isophthalamide), poly(parabenzamide), poly(metabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), a paraphenylene terephthalamide/2,6-dichloroparaphenylene terephthalamide copolymer, and a methaphenylene terephthalamide/2,6-dichloroparaphenylene terephthalamide copolymer. Among these aromatic polyamides, poly(paraphenylene terephthalamide) is more preferable.

Among the above resins, a polyolefin, a fluorine-containing resin, an aromatic polyamide, a water-soluble polymer, or the water-insoluble polymer in the form of particles dispersed in the aqueous solvent is more preferable. Among these resins, in a case where the porous layer is arranged so as to face a positive electrode, a fluorine-containing resin is still more preferable, and a polyvinylidene fluoride-based resin is particularly preferable. This is because such a resin makes it easy to maintain various properties, such as a rate characteristic and a resistance characteristic (solution resistance), of a nonaqueous electrolyte secondary battery even in a case where the nonaqueous electrolyte secondary battery suffers acidic deterioration during operation of the nonaqueous electrolyte secondary battery. Examples of the polyvinylidene fluoride-based resin encompass: a homopolymer of vinylidene fluoride (that is, polyvinylidene fluoride); and a copolymer of vinylidene fluoride and at least one monomer selected from the group consisting of hexafluoropropylene, tetrafluoroethylene, trifluoroethylene, trichloroethylene, and vinyl fluoride is particularly preferable.

Further, the water-soluble polymer or the water-insoluble polymer which is in the form of particles dispersed in the aqueous solvent is more preferable in view of a process and an environmental impact, because water can be used as a solvent to form the porous layer. The water-soluble polymer is still more preferably cellulose ether or sodium alginate, and particularly preferably cellulose ether.

Specific examples of the cellulose ether encompass carboxymethyl cellulose (CMC), hydroxyethyl cellulose (HEC), carboxyethyl cellulose, methyl cellulose, ethyl cellulose, cyanoethyl cellulose, and oxyethyl cellulose. The cellulose ether is more preferably CMC or HEC, and particularly preferably CMC, because CMC and HEC degrade less over an extended period of time of use and are excellent in chemical stability.

In view of adhesiveness of particles of an aramid filler, the water-insoluble polymer in the form of particles dispersed in the aqueous solvent is preferably a homopolymer of an acrylate monomer, such as methyl methacrylate, ethyl methacrylate, glycidyl methacrylate, glycidyl acrylate, methyl acrylate, ethyl acrylate, or butyl acrylate. Alternatively, the water-insoluble polymer is preferably a copolymer of two or more kinds of the monomers.

The porous layer in accordance with an embodiment of the present invention can include another component other than the aramid filler and the resin. Examples of such another component encompass a surfactant and wax. Such another component is contained in an amount of preferably 0% by weight to 50% by weight, relative to a total weight of the porous layer.

The porous layer in accordance with an embodiment of the present invention has a thickness of preferably 0.5 μm to 15 μm and more preferably 2 μm to 10 μm. Note that the thickness is intended to be a thickness of the porous layer per surface of the nonaqueous electrolyte secondary battery laminated separator described later. In a case where the porous layer has a thickness of not less than 0.5 μm, it is possible to (i) sufficiently prevent a short circuit from occurring in a battery and (ii) allow an amount of electrolyte retained in the porous layer to be maintained. Meanwhile, in a case where the porous layer has a thickness of not more than 15 μm, it is possible to (i) restrict an increase in resistance to ion permeation, (ii) prevent a positive electrode from deteriorating in a case where a charge-discharge cycle is repeated and (iii) prevent a rate characteristic and a cycle characteristic from deteriorating in a case where a charge-discharge cycle is repeated. In addition, an increase in distance between the positive electrode and a negative electrode is restricted, so that the nonaqueous electrolyte secondary battery can be prevented from being large in size.

In view of adhesiveness of the porous layer to an electrode and ion permeability of the porous layer, a weight per unit area of the porous layer is, preferably 0.5 g/m² to 20 g/m², more preferably 0.5 g/m² to 10 g/m², and still more preferably 0.5 g/m² to 7 g/m², in terms of solid content.

<Method of Producing Porous Layer>

The porous layer can be produced by, for example, the following method. First, a solution, in which the above-described aramid is dissolved in a solvent, is obtained. Then, the solution is heated so that the aramid is deposited. This produces a suspension containing an aramid filler. The suspension can be used as a coating solution for the formation of the porous layer. Alternatively, a coating solution can be prepared by adding, to the suspension, (i) the above-described another component and (ii) a filler other than the aramid filler. Alternatively, it is possible to prepare a coating solution by (i) taking out the aramid filler by filtering the suspension containing the aramid filler and then (ii) dispersing the aramid filler in a dispersion medium such as water. Note that the aramid filler, which has been taken out, can easily be aggregated. When the aramid filler thus taken out is dispersed in the dispersion medium, therefore, it is preferable to crush the aramid filler which has been aggregated. Then, the porous layer can be formed by (i) coating a base material with the coating solution obtained as described above and then (ii) removing the solvent or the dispersion medium by drying or the like.

The particle diameter and the aspect ratio of the aramid filler can be controlled by using the above-described method of producing the porous layer in accordance with an embodiment of the present invention. An example of a specific method of producing the porous layer will be described in Examples. Needless to say, however, such a specific method is not limited to the method described in Examples.

Examples of the base material encompass a polyolefin porous film and an electrode (described later). Examples of the solvent encompass N-methylpyrrolidone, N,N-dimethylacetamide, and N,N-dimethylformamide.

A method of coating the base material with the coating solution encompass publicly known coating methods such as that in which a knife, a blade, a bar, a gravure, or a die is used. A method of removing the solvent is a typical drying method. Examples of the drying method encompass natural drying, air-blowing drying, heat drying, and drying under reduced pressure. Note, however, that any method can be used, provided that the solvent can be sufficiently removed. In addition, a drying step can be carried out after the solvent or the dispersion medium contained in the coating solution is replaced with another solvent. Specific examples of the method, in which the solvent is replaced with another solvent and then the another solvent is removed, encompass a method in which (i) the solvent is replaced with a poor solvent having a low boiling point, such as water, alcohol, and acetone and (ii) the drying step is carried out.

[2. Nonaqueous Electrolyte Secondary Battery Laminated Separator]

A laminated separator for a nonaqueous electrolyte secondary battery in accordance with an embodiment of the present invention (hereinafter referred to as a “nonaqueous electrolyte secondary battery laminated separator” or simply referred to as “laminated separator”) includes (i) a polyolefin porous film and (ii) the above-described porous layer disposed on at least one surface of the polyolefin porous film. The porous layer can be a layer which, serving as an outermost layer of the laminated separator, comes into contact with an electrode. The porous layer can be disposed on one surface or both surfaces of the polyolefin porous film.

<Polyolefin Porous Film>

The polyolefin porous film can serve as a base material of the laminated separator. The polyolefin porous film has therein many pores connected to one another, so that a gas or a liquid can pass through the polyolefin porous film from one surface to the other.

The “polyolefin porous film” means a porous film containing a polyolefin-based resin as a main component. The expression that a “porous film contains a polyolefin-based resin as a main component” means that the polyolefin-based resin accounts for not less than 50% by volume, preferably not less than 90% by volume, and more preferably not less than 95% by volume, of the entire material constituting the porous film.

Examples of the polyolefin-based resin encompass a homopolymer and a copolymer, any of which is obtained through (co)polymerization of a monomer such as ethylene, propylene, 1-butene, 4-methyl-1-pentene, and 1-hexene (which are thermoplastic resins). Examples of the homopolymer encompass polyethylene, polypropylene, and polybutene. Examples of the copolymer encompass an ethylene-propylene copolymer. Among these, polyethylene is preferable because it is capable of preventing (shutting down) a flow of an excessively large electric current at a lower temperature.

The polyolefin porous film has a thickness of preferably 4 μm to 40 μm and more preferably 5 μm to 20 μm. In a case where the polyolefin porous film has a thickness of not less than 4 μm, it is possible to sufficiently prevent a short circuit in a battery. Meanwhile, in a case where the polyolefin porous film has a thickness of not more than 40 μm, it is possible to (i) restrict an increase in resistance to ion permeation, (ii) prevent a positive electrode from deterioration which occurs due to repetitive charge-discharge cycles and (iii) prevent a rate characteristic and a cycle characteristic from deteriorating due to repetitive charge-discharge cycles. In addition, an increase in size of the nonaqueous electrolyte secondary battery, which occurs due to an increase in distance between the positive electrode and a negative electrode, can be prevented.

The polyolefin porous film has a porosity of preferably 20% by volume to 80% by volume and more preferably 30% by volume to 75% by volume. In a case where the porosity falls within these ranges, it is possible to (i) retain a larger amount of an electrolyte and (ii) reliably prevent (shut down) a flow of an excessively large electric current at a lower temperature. In a case where the porosity is not less than 20% by volume, it is possible to restrict resistance of the polyolefin porous film to ion permeation. The porosity is preferably not more than 80% by volume in view of mechanical strength of the polyolefin porous film.

<Method of Producing Polyolefin Porous Film>

A method of producing the polyolefin porous film can be, for example, a method in which (i) a pore forming agent is added to a polyolefin-based resin so as to form a film and then (ii) the pore forming agent is removed with use of an appropriate solvent.

Specifically, in a case where, for example, a polyolefin-based resin, which contains ultra-high molecular weight polyethylene and low molecular weight polyolefin which has a weight-average molecular weight of not more than 10,000, is used, it is preferable in view of production costs that the polyolefin porous film is produced by a method including:

(1) kneading 100 parts by mass of ultra-high molecular weight polyethylene, 5 parts by mass to 200 parts by mass of low molecular weight polyolefin having a weight-average molecular weight of not more than 10,000, and 100 parts by mass to 400 parts by mass of a pore forming agent, so as to obtain a polyolefin resin composition; and
(2) forming the polyolefin resin composition into a rolled sheet by rolling,
(3) removing the pore forming agent from the rolled sheet obtained in the step (2);
(4) stretching the sheet obtained in the step (3), so as to obtain the polyolefin porous film.

Examples of the pore forming agent encompass an inorganic bulking agent and a plasticizer. Examples of the inorganic bulking agent encompass an inorganic filler. Examples of the plasticizer encompass a low molecular weight hydrocarbon such as liquid paraffin.

<Method of Producing Nonaqueous Electrolyte Secondary Battery Laminated Separator>

A method of producing the nonaqueous electrolyte secondary battery laminated separator in accordance with an embodiment of the present invention can be, for example, the above-described method of producing the porous layer in which polyolefin porous film is used as a base material which is coated with the coating solution.

[3. Nonaqueous Electrolyte Secondary Battery Member, Nonaqueous Electrolyte Secondary Battery]

A nonaqueous electrolyte secondary battery member in accordance with an embodiment of the present invention includes a positive electrode, the above-described porous layer or the above-described laminated separator, and a negative electrode such that the positive electrode, the porous layer or the laminated separator, and the negative electrode are arranged in this order. A nonaqueous electrolyte secondary battery in accordance with an embodiment of the present invention includes the above-described porous layer or the above-described laminated separator. The nonaqueous electrolyte secondary battery typically has a structure in which the negative electrode and the positive electrode face each other through the porous layer or the laminated separator. The nonaqueous electrolyte secondary battery is configured so that a battery element is enclosed in an exterior member, the battery element including (i) the structure and (ii) an electrolyte with which the structure is impregnated. For example, the nonaqueous electrolyte secondary battery is a lithium ion secondary battery which achieves an electromotive force through doping with and dedoping of lithium ions.

<Positive Electrode>

Examples of the positive electrode encompass a positive electrode sheet having a structure in which an active material layer including a positive electrode active material and a binder resin is formed on a current collector. The active material layer can further include an electrically conductive agent.

The positive electrode active material is, for example, a material capable of being doped with and dedoped of lithium ions. Examples of such a material encompass a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound.

Examples of the binding agent encompass: thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, a thermoplastic polyimide, polyethylene, and polypropylene; acrylic resin; and styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

The positive electrode sheet can be produced by, for example, (I) a method in which pressure is applied to the positive electrode active material, the electrically conductive agent, and the binding agent on the positive electrode current collector to form a positive electrode mix thereon or (II) a method in which (i) an appropriate organic solvent is used so that the positive electrode active material, the electrically conductive agent, and the binding agent will be in a paste form to provide a positive electrode mix, (ii) the positive electrode mix is applied to the positive electrode current collector, (iii) the applied positive electrode mix is dried so that a sheet-shaped positive electrode mix is prepared, and then (iv) pressure is applied to the sheet-shaped positive electrode mix so that the sheet-shaped positive electrode mix is firmly fixed to the positive electrode current collector.

<Negative Electrode>

Examples of the negative electrode encompass a negative electrode sheet having a structure in which an active material layer including a negative electrode active material and a binder resin is formed on a current collector. The active material layer can further include an electrically conductive agent.

Examples of the negative electrode active material encompass (i) a material capable of being doped with and dedoped of lithium ions, (ii) a lithium metal, and (iii) a lithium alloy. Examples of the material encompass: carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode; metals such as aluminum (Al), lead (Pb), tin (Sn), bismuth (Bi), or silicon (Si), each of which is alloyed with alkali metal; cubic intermetallic compounds (AlSb, Mg₂Si, and NiSi₂) having lattice spaces in which alkali metals can be provided; and lithium nitrogen compounds (Li₃₋ₓMₓN (where M represents a transition metal)).

Examples of the negative electrode current collector encompass Cu, Ni, and stainless steel. Among these, Cu is preferable because it is not easily alloyed with lithium in the case of particularly a lithium-ion secondary battery and is easily processed into a thin film.

The negative electrode sheet can be produced, by, for example, (I) a method in which pressure is applied to the negative electrode active material on the negative electrode current collector to form a negative electrode mix thereon or (II) a method in which (i) an appropriate organic solvent is used so that the negative electrode active material will be in a paste form to provide a negative electrode mix, (ii) the negative electrode mix is applied to the negative electrode current collector, (iii) the applied negative electrode mix is dried so that a sheet-shaped negative electrode mix is prepared, and then (iv) pressure is applied to the sheet-shaped negative electrode mix so that the sheet-shaped negative electrode mix is firmly fixed to the negative electrode current collector. The above paste preferably includes the electrically conductive agent and the binding agent.

<Nonaqueous Electrolyte>

A nonaqueous electrolyte is, for example, a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Examples of the organic solvent encompass: carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into any of the organic solvents described above. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is still more preferably a mixed solvent of ethylene carbonate, dimethyl carbonate, and ethyl methyl carbonate. This is because such a mixed solvent leads to a wider operating temperature range, and is not easily decomposed even in a case where a negative electrode active material is a graphite material such as natural graphite or artificial graphite.

<Nonaqueous Electrolyte Secondary Battery Member Production Method and Nonaqueous Electrolyte Secondary Battery Production Method>

The nonaqueous electrolyte secondary battery member can be produced by, for example, arranging the positive electrode, the above-described porous layer or the above-described laminated separator, and the negative electrode in this order.

Alternatively, the nonaqueous electrolyte secondary battery can be produced by, for example, as follows. First, a nonaqueous electrolyte secondary battery member is placed in a container which serves as a housing of the nonaqueous electrolyte secondary battery. Then, the container is filled with a nonaqueous electrolyte. Then, while pressure inside the container is being reduced, the container is hermetically sealed. This produces the nonaqueous electrolyte secondary battery.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in more detail by Examples. Note, however, that the present invention is not limited to these Examples. In each of Examples, the heat resistance of a laminated porous film was evaluated with a dimensional retention as an index.

<Measuring Method and Evaluating Method>

In each of Examples below, physical properties of a laminated porous film (laminated separator) were measured and evaluated by a method described below.

(1) Measurement of Particle Diameter of Aramid Filler

With use of a solution containing an aramid filler obtained in each of Production Examples below, a particle diameter of the aramid filler was measured by the following method (a) or (b).

(a) A solution containing an aramid filler obtained in Production Example below was subjected to an ultrasound method with use of DT-1202 manufactured by Dispersion Technology, so that a particle diameter was calculated.
(b) A solution, which contained an aramid filler obtained in Production Example, was dried on a glass plate. Then, an SEM surface observation (observation of a reflection electron image) was performed at an acceleration voltage of 0.5 kV with use of a field emission scanning electrode microscope JSM-7600F manufactured by JEOL Ltd., so that an electron micrograph (SEM image) at a magnification of 10,000 times was obtained. Then, (i) the SEM image obtained was imported into a computer, (ii) the image was, with use of free software IMAGEJ for image analysis (distributed by National Institutes of Health (NIH), divided at a luminance at which the aramid filler particles were detectable, and (iii) luminance holes were filled so that all areas inside the aramid filler were detectable as aramid filler areas. Then, a long axis of each of 111 aramid filler particles (which were all of the aramid filler particles detected) was calculated. An average value of the long axes of the aramid filler particles thus calculated was used as a particle diameter of the aramid filler.

(2) Measurement of Aspect Ratio of Aramid Filler

By a method similar to that used in (1) (b) above, an aspect ratio of each of the 111 aramid filler particles was calculated, and an average value of the aspect ratios thus calculated was used as an aspect ratio of a projection image of the aramid filler. Specifically, the aspect ratio of each particle of the aramid filler was a value obtained by (i) approximating the shape of each particle of the aramid filler to an elliptical shape, (ii) calculating a long-axis diameter and a short-axis diameter of the elliptical shape, and (iii) dividing the long-axis diameter by the short-axis diameter.

(3) Air Permeability as Measured Through Gurley Method (Sec/100 Cc)

In conformity with a JIS P 8117, air permeability of the laminated porous film was measured with the use of a digital timer Gurley densometer manufactured by YASUDA SEIKI SEISAKUSHO, LTD.

(4) Dimensional Retention

A test piece having a 5 cm×5 cm square shape was cut out from a laminated porous film. At a center of the test piece, a 4 cm×4 cm square was drawn by marking lines. This test piece was sandwiched between 2 sheets of paper, and was held in an oven at 150° C. for 1 hour. Then, the test piece was taken out of the oven, and dimensions of the marking lines of the square were measured. From the dimensions thus obtained, a dimensional retention was calculated. A method of calculating the dimensional retention is as follows. Note that the term “widthwise (TD)” indicates a direction which is perpendicular to a machine direction.

Widthwise (TD) dimensional retention (%)=W2/W1×100

where (i) W1 is a widthwise (TD) length of a marking line before heating and (ii) W2 is a widthwise (TD) length of a marking line after heating.

### Production Example 1 of Aramid Filler

(Aramid Polymerization Solution)

Poly(paraphenylene terephthalamide) was produced with use of a 500-mL separable flask having a stirring blade, a thermometer, a nitrogen incurrent canal, and a powder addition port. Specifically, 440 g of N-methyl-2-pyrrolidone (NMP) was introduced in the flask which had been sufficiently dried. Then, 30.2 g of calcium chloride powder, which had been vacuum-dried at 200° C. for 2 hours, was added. Then, the temperature was raised to 100° C. so that the calcium chloride powder was completely dissolved. The temperature of the resultant solution was returned to room temperature, and then 13.2 g of paraphenylenediamine was added. Then, the paraphenylenediamine was completely dissolved. While the temperature of the resultant solution was maintained at 20° C.±2° C., 23.47 g of terephthalic acid dichloride was added in 4 separate portions at intervals of approximately 10 minutes. Then, while the resultant solution was being stirred at 150 rpm and maintained at 20° C.±2° C., the solution was matured for 1 hour. This produced an aramid polymerization solution.

(Method of Preparing Solution Containing Aramid Filler)

The aramid polymerization solution obtained was stirred at 40° C. at 300 rpm for 1 hour so that poly(paraphenylene terephthalamide) was deposited. This produced a solution containing an aramid filler.

### Production Example 2 of Aramid Filler>

(Aramid Polymerization Solution)

Poly(paraphenylene terephthalamide) was produced with use of a 500-mL separable flask having a stirring blade, a thermometer, a nitrogen incurrent canal, and a powder addition port. Specifically, 440 g of N-methyl-2-pyrrolidone (NMP) was introduced in the flask which had been sufficiently dried. Then, 30.2 g of calcium chloride powder, which had been vacuum-dried at 200° C. for 2 hours, was added. Then, the temperature was raised to 100° C. so that the calcium chloride powder was completely dissolved. The temperature of the resultant solution was returned to room temperature, and then 13.2 g of paraphenylenediamine was added. Then, the paraphenylenediamine was completely dissolved. While the temperature of the resultant solution was maintained at 20° C.±2° C., 23.47 g of terephthalic acid dichloride was added in 4 separate portions at intervals of approximately 10 minutes. Then, while the resultant solution was being stirred at 150 rpm and maintained at 20° C.±2° C., the solution was matured for 1 hour. This produced an aramid polymerization solution.

(Method of Preparing Solution Containing Aramid Filler)

The aramid polymerization solution obtained was stirred at 55° C. at 300 rpm for 3 hours so that poly(paraphenylene terephthalamide) was deposited. This produced a solution containing an aramid filler.

### Production Example 3 of Aramid Filler>

(Aramid Polymerization Solution)

Poly(paraphenylene terephthalamide) was produced with use of a 500-mL separable flask having a stirring blade, a thermometer, a nitrogen incurrent canal, and a powder addition port. Specifically, 440 g of N-methyl-2-pyrrolidone (NMP) was introduced in the flask which had been sufficiently dried. Then, 30.2 g of calcium chloride powder, which had been vacuum-dried at 200° C. for 2 hours, was added. Then, the temperature was raised to 100° C. so that the calcium chloride powder was completely dissolved. The temperature of the resultant solution was returned to room temperature, and then 13.2 g of paraphenylenediamine was added. Then, the paraphenylenediamine was completely dissolved. While the temperature of the resultant solution was maintained at 20° C.±2° C., 24.2 g of terephthalic acid dichloride was added in 4 separate portions at intervals of approximately 10 minutes. Then, while the resultant solution was being stirred at 150 rpm and maintained at 20° C.±2° C., the solution was matured for 1 hour. This produced an aramid polymerization solution.

(Method of Preparing Solution Containing Aramid Filler)

The aramid polymerization solution obtained was stirred at 55° C. at 300 rpm for 3 hours so that poly(paraphenylene terephthalamide) was deposited. This produced a solution containing an aramid filler.

### Example 1

The solution containing the aramid filler, which was obtained in Production Example 1, was used as a coating solution. A porous film made of polyethylene (having a thickness of 12 μm and a porosity of 41%) was coated with the coating solution by a doctor blade method. A laminated body, which was the resultant coated product, was rested in air at a temperature of 50° C. and at a relative humidity of 70% for 1 minute. Then, the laminated body was cleaned by being in immersed in ion exchange water. Then, the resultant product was dried in an oven at 70° C. This produced a laminated porous film (1) including a porous layer and the porous film made of polyethylene, the porous layer and the porous film being disposed on each other. A weight per unit area of the porous layer in the laminated porous film (1) was 3.0 g/m². Physical properties of the laminated porous film (1) are shown in Table 1.

### Example 2

A coating solution was changed from that used in Example 1 to another one. Specifically, a coating solution was prepared by adding Alumina C (manufactured by Nippon Aerosil Co., Ltd.) and NMP to the solution containing the aramid filler, which was obtained in Production Example 2. A weight ratio between poly(paraphenylene terephthalamide) and Alumina C in the coating solution was 1:1. In addition, an amount of NMP added was set so that a solid content (a ratio of the weights of the poly(paraphenylene terephthalamide) and the Alumina C to the weight of the coating solution) would account for 3% by weight. Other than the above conditions for the coating solution, a laminated porous film (2) was obtained as in Example 1. A weight per unit area of the porous layer in the laminated porous film (2) was 1.7 g/m². Physical properties of the laminated porous film (2) are shown in Table 1.

### Example 3

A coating solution was changed from that used in Example 1 to another one. Specifically, a coating solution was prepared by adding Alumina C (manufactured by Nippon Aerosil Co., Ltd.) and NMP to the solution containing the aramid filler, which was obtained in Production Example 3. A weight ratio between poly(paraphenylene terephthalamide) and Alumina C in the coating solution was 1:1. In addition, an amount of NMP added was set so that a solid content (a ratio of the weights of the poly(paraphenylene terephthalamide) and the Alumina C to the weight of the coating solution) would account for 3% by weight. Other than the above conditions for the coating solution, a laminated porous film (3) was obtained as in Example 1. A weight per unit area of the porous layer in the laminated porous film (3) was 1.5 g/m². Physical properties of the laminated porous film (3) are shown in Table 1.

### Comparative Example 1

A coating solution was changed from that used in Example 1 to another one. Specifically, the aramid polymerization solution obtained in Production Example 3 was used as a coating solution. In other words, a liquid containing no aramid filler was used as coating solution. Other than the above conditions for the coating solution, a laminated porous film (4) was obtained as in Example 1. A weight per unit area of the porous layer in the laminated porous film (4) was 1.9 g/m². Physical properties of the laminated porous film (4) are shown in Table 1.

### Comparative Example 2

A coating solution was changed from that used in Example 1 to another one. Specifically, the solution containing the aramid filler, which was obtained in Production Example 1, was filtered and then dried, so that the aramid filler was obtained. 100 parts by mass of the aramid filler thus obtained and 3 parts by mass of carboxymethyl cellulose (product No. 1110, manufactured by Daicel FineChem Ltd.) were added to water, so that a mixed solution was obtained. An amount of water added was set so that a solid content (a ratio of the weights of the aramid filler and the carboxymethyl cellulose to the weight of the mixed solution) would account for 29% by weight. The mixed solution was mixed by being stirred twice. Each time, the mixed solution was stirred at 2000 rpm for 30 seconds at room temperature with use of a planetary centrifugal mixer, “AWATORI RENTARO” (registered trademark; manufactured by Thinky Corporation). To the mixed solution thus stirred, 14 parts by mass of isopropyl alcohol was added. This produced a coating solution, which was a slurry containing a solid content (a ratio of the weights of the aramid filler and the carboxymethyl cellulose to the weight of the coating solution) in an amount of 28% by weight. Other than the above conditions for the coating solution, a laminated porous film (5) was obtained as in Example 1. A weight per unit area of the porous layer in the laminated porous film (5) was 10.2 g/m². Physical properties of the laminated porous film (5) are shown in Table 1.

TABLE 1

| | Particle | | Air | Dimensional |
|---|---|---|---|---|
| | diameter | Aspect | permeability | retention |
| | (μm) | ratio | (sec/100 cc) | (%) |
| Example 1 | 0.83 | 1.4 | 241 | 73 |
| Example 2 | 0.04 | 1.5 | 252 | 70 |
| Example 3 | 8.49 | 1.5 | 279 | 93 |
| Comparative | — | — | 692 | 95 |
| Example 1 | | | | |
| Comparative | 18.2 | 1.7 | 338 | 40 |
| Example 2 | | | | |

Table 1 shows that the laminated porous films produced in Examples 1 through 3 each had lowered air permeability. This indicates excellent ion permeability. It was also found that the laminated porous films produced in Examples 1 through 3 each had excellent heat resistance. Meanwhile, the laminated porous film produced in Comparative Example 1 had high air permeability. The laminated porous film produced in comparative Example 2 had low heat resistance.

### INDUSTRIAL APPLICABILITY

A porous layer in accordance with an embodiment of the present invention and a nonaqueous electrolyte secondary battery laminated separator including the porous layer each have excellent heat resistance and excellent ion permeability, and can each be put to a wide range of use in the field of nonaqueous electrolyte secondary battery production.

1. A nonaqueous electrolyte secondary battery porous layer comprising:
an aramid filler,
the aramid filler having a particle diameter of 0.01 μm to 10 μm.

2. The nonaqueous electrolyte secondary battery porous layer as set forth in claim 1, wherein
an aspect ratio of a projection image of the aramid filler is in a range of 1 to 100.

3. A nonaqueous electrolyte secondary battery laminated separator comprising:
a polyolefin porous film; and
a nonaqueous electrolyte secondary battery porous layer recited in claim 1, the nonaqueous electrolyte secondary battery porous layer being disposed on at least one surface of the polyolefin porous film.

4. A nonaqueous electrolyte secondary battery member comprising:
a positive electrode;
a nonaqueous electrolyte secondary battery porous layer recited in claim 1; and
a negative electrode,
the positive electrode, the nonaqueous electrolyte secondary battery porous layer, and the negative electrode being arranged in this order.

5. A nonaqueous electrolyte secondary battery comprising:
a nonaqueous electrolyte secondary battery porous layer recited in claim 1.

6. A nonaqueous electrolyte secondary battery member comprising:
a positive electrode;
a nonaqueous electrolyte secondary battery laminated separator recited in claim 3; and
a negative electrode,
the positive electrode, the nonaqueous electrolyte secondary battery laminated separator, and the negative electrode being arranged in this order.

7. A nonaqueous electrolyte secondary battery comprising:
a nonaqueous electrolyte secondary battery laminated separator recited in claim 3.
